(19) United States
(12) Patent Application Publication
(10) Pub. No.: US 2020/0272519 A1
(43) Pub. Date: Aug. 27, 2020

(54) MEMORY RESOURCE ALLOCATION FOR AUDIO AND NON-MULTIMEDIA SUBSYSTEMS

(71) Applicant: QUALCOMM Incorporated, San Diego, CA (US)

(72) Inventors: Gur Prasad SRIVASTAVA, Bengaluru (IN); Manish AGARWAL, Bangalore (IN)

(21) Appl. No.: 16/287,057

(22) Filed: Feb. 27, 2019

(51) Int. Cl. G06F 9/50; G06F 3/16

(52) U.S. Cl. CPC G06F 9/5016; G06F 9/5038; G06F 9/505; G06F 3/165

(57) ABSTRACT

In some aspects, the present disclosure provides a method of allocating memory resources on a system-on-chip (SoC). The method includes receiving audio data from a first master, the first master being an audio subsystem. The method further includes receiving non-multimedia data from a second master, the second master being a non-multimedia subsystem. The method also includes communicating the audio data to a first partition of the memory management unit circuit, where the first partition is configured to be accessible by the first master and not the second master. The method further includes communicating the non-multimedia data to a second partition of the memory management unit circuit, where the second partition is configured to be accessible by the second master and not the first master, and where communication of the audio data is prioritized over communication of the non-multimedia data.

### TECHNICAL FIELD

The teachings of the present disclosure relate generally to system-on-chip (SoC) integrated circuit design, and more particularly, to allocation of memory resources on an SoC.

### INTRODUCTION

Computing devices are becoming more ubiquitous as the devices become more portable. As the use of portable devices such as mobile phones, tablets, and laptop computers increases, so too does the functionality required of such devices. For example, while a cellular phone may have a primary function relating to voice and text communications, modern cellular phones may also include peripheral functions relating to video and still cameras, global positioning system (GPS) navigation, web browsing, and network managing. Many of these devices include a system-on-chip (SoC) having a range of subsystems and circuit components configured to support these primary and peripheral functions. Each subsystem may include multiple computing cores and volatile memory (e.g., registers, cache, such as L1, L2, L3 cache, main memory, etc.) associated with the multiple computing cores. For example, a central processing unit (CPU) subsystem may include multiple CPU cores embedded in an integrated circuit or SoC and coupled to a local bus or interconnect. The CPU cores may further be arranged into one or more computing clusters, each cluster including one or more cores.

Accordingly, in order to govern interoperability and facilitate communication between the circuit components, the SoC may utilize advanced interconnects, such as high performance networks-on-chip (NoCs). A NoC may arbitrate data communication by time-multiplexing data according to a quality of service (QoS), or priority, of the data. As such, certain data can be communicated by the NoC with a higher priority than other data.

Due to the rapid rate at which technology evolves, computing devices are increasingly dependent on the functionality of many different primary and peripheral electronic components. Speed, accuracy, and cost efficiency are particularly important in the SoCs that are used in consumer computing devices. Accordingly, new and improved circuits, components, systems, and solutions that better meet these and other demands of modern and future computing devices will be beneficial to electronics and computer manufacturers, and their consumers.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure describes a system on a chip (SoC) that includes a first master including an audio subsystem. The SoC also includes a second master including a non-multimedia subsystem. The SoC also includes a memory management unit (MMU) circuit having a first partition and a second partition, wherein the first partition is configured to be accessible by the first master and not the second master, and wherein the second partition is configured to be accessible by the second master and not the first master. The SoC also includes an interconnect configured to provide communication between the first master, the second master, and the MMU. The SoC is also configured to receive audio data from the first master. The SoC is further configured to receive non-multimedia data from the second master. The SoC is also configured to communicate the audio data to the first partition of the MMU. The SoC is also configured to communicate the non-multimedia data to the second partition of the MMU, wherein communication of the audio data over the interconnect is prioritized over communication of the non-multimedia data.

In some aspects, the present disclosure describes a method of sharing a MMU between an audio subsystem and a non-multimedia subsystem. The method includes receiving, via an interconnect, audio data from a first master, the first master comprising the audio subsystem. The method also includes receiving, via the interconnect, non-multimedia data from a second master, the second master comprising the non-multimedia subsystem. The method also includes communicating, via the interconnect, the audio data to a first partition of the MMU, wherein the first partition is configured to be accessible by the first master and not the second master. The method also includes communicating, via the interconnect, the non-multimedia data to a second partition of the MMU, wherein the second partition is configured to be accessible by the second master and not the first master, and wherein communication of the audio data over the interconnect is prioritized over communication of the non-multimedia data.

In some aspects, the present disclosure provides an apparatus including a a means for generating audio data. The apparatus also includes a means for generating non-multimedia data. The apparatus also includes a means for storing, where the means for storing includes a first partition and a second partition, wherein the first partition is configured to be accessible by the audio data and not the non-multimedia data, and wherein the second partition is configured to be accessible by the non-multimedia data and not the audio data. The apparatus also includes a means for communicating between the means for generating audio data, the means for generating non-multimedia data, and the means for storing. The means for communicating is also configured to receive audio data from the means for generating audio data. The means for communicating is also configured to receive non-multimedia data from the means for generating non-multimedia data. The means for communicating is also configured to communicate the audio data to the first partition. The means for communicating is also configured to communicate the non-multimedia data to the second partition, wherein communication of the audio data is prioritized over communication of the non-multimedia data.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram of example components and interconnections of a system-on-chip (SoC) suitable for implementing various aspects of the present disclosure.

FIG. 2 is a block diagram conceptually illustrating an example of a hardware implementation for executing various aspects of an audio subsystem, according to some aspects of the disclosure.

FIG. 3 is a flow diagram illustrating an example method for sharing a memory resource between an audio subsystem master and a non-multimedia master, according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Although the teachings of this disclosure are illustrated in terms of integrated circuits (e.g., a system-on-chip (SoC)), the teachings are applicable in other areas. The teachings disclosed should not be construed to be limited to SoC designs or the illustrated embodiments. The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of integrated circuits. The illustrated embodiments are merely vehicles to describe and illustrate examples of the inventive teachings disclosed herein.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores. For example, a single integrated circuit (IC) chip or chip package may be configured to read and execute program instructions utilizing two or more independent processing units or cores (e.g., CPU cores, etc.) configured to read and execute program instructions.

A number of different types of memories and memory technologies are available or contemplated in the future, all of which are suitable for use with the various aspects. Such memory technologies/types include phase change memory (PRAM), dynamic random-access memory (DRAM), static random-access memory (SRAM), non-volatile random-access memory (NVRAM), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies include, for example, computer-readable mediums having elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language.

Certain aspects of the present disclosure propose techniques for prioritizing and managing memory resources of audio subsystems and non-multimedia subsystems of an SoC. For example, certain aspects relate to techniques for reducing the amount of dedicated hardware required in production of the SoC, thereby increasing available space and reducing costs associated with manufacturing, while also ensuring key standards of audio performance are maintained. Though certain aspects are discussed with respect to audio subsystems and respective non-multimedia subsystems, it should be recognized that similar techniques may be applicable to similar multimedia subsystems instead of audio subsystems, or other groups of subsystems that have similar data requirements.

In one example, data latencies that occur on the order of nano-seconds in audio subsystems may reduce the quality of a user experience. Manufacturers may generally follow key performance standards for maintaining certain quality levels in the functionality of audio subsystems, as well as other subsystems. Accordingly, certain aspects herein relate to reducing the amount of hardware required on an SoC, and likewise, reducing the costs of manufacturing the SoC while maintaining the performance standards. In one example embodiment, a memory management unit (MMU) circuit (e.g., a translation buffer unit) is shared by an audio subsystem and a non-multimedia subsystem. As such, the MMU handles memory and caching operations associated with both the audio and non-multimedia subsystems. The various aspects may be implemented in a wide variety of computing systems, including single processor systems, multiprocessor systems, multicore processor systems, SoC, or any combination thereof.

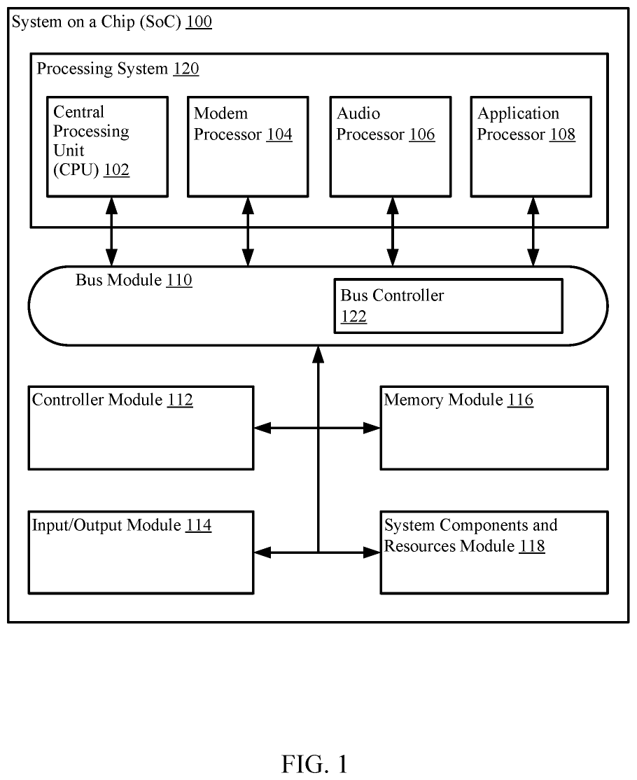

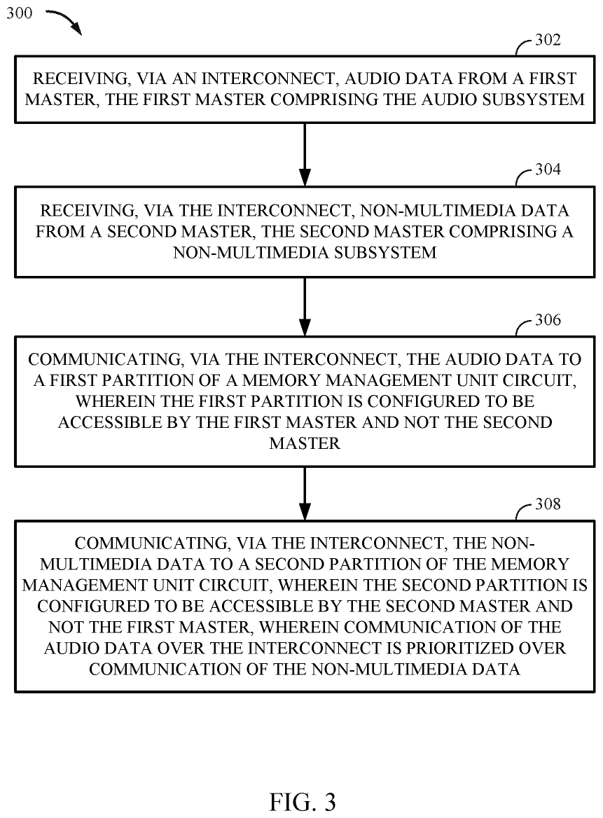

FIG. 1 is a block diagram conceptually illustrating an example hardware implementation of an SoC 100 suitable for performing various aspects of the present disclosure. It should be noted that the SoC 100 described with respect to FIG. 1 is merely an example structure of an SoC 100, and any specific number of elements (e.g., modules, circuit components, etc.) may be omitted for a particular implementation. The SoC 100 may employ a processing system 120 that includes one or more processors configured to perform the various functions described throughout this disclosure. That is, the processing system 120, as utilized in the SoC 100, may be used to execute instructions stored on a computer-readable medium to implement any one or more of the processes described herein, for example, in FIG. 3.

The processing system 120 may include a number of heterogeneous processors, such as a central processing unit (CPU) 102, a modem processor 104, an audio processor 106, and an application processor 108. Each processor 102, 104, 106, 108, may include one or more cores, and each processor/core may perform operations independent of the other processors/cores. Each processor 102, 104, 106, 108 may include part of a subsystem including one or more processors, caches, etc., configured to handle certain types of tasks or computations.

One or more of the processors 102, 104, 106, 108 may include an audio DSP (ADSP) configured to process audio signals. In one example, the audio processor 106 may include an ADSP and a direct memory access (DMA) unit. The ADSP may be configured to process audio signals, such as voice (e.g., phone call, voicemail, etc.) and content (e.g., music, radio/media playback, etc.). The DMA may be configured to communicate audio data, requests, interrupts, and other indications or status of the audio processor 106.

The SoC 100 may include a system components and resources module 118 configured for managing sensor data, power control and distribution, analog-to-digital conversions, wireless data transmissions, and for performing other specialized operations (e.g., decoding/processing video, etc.). System components and resources module 118 may also include circuit components such as voltage regulators, oscillators, phase-locked loops, peripheral bridges, data controllers, system controllers, access ports, timers, and other similar components used to support the processors and software clients running on the computing device. The system components and resources module 118 may also include circuitry for interfacing with peripheral devices, such as cameras, electronic displays, wireless communication devices, external memory chips, etc.

The SoC 100 may include a memory module 116 configured to store instructions executable on a processor. The memory module 116 may include one or more memory devices. The memory devices may be an on-chip circuit component (e.g., on the substrate, die, integrated chip, etc.) of the SoC 100, or alternatively, an off-chip component. In some aspects of the disclosure, the memory module 116 may include communication instructions for performing various operations related to the allocation of memory resources for audio and non-multimedia subsystems as described herein. In some aspects of the disclosure, the memory module 116 may include processing instructions for performing various operations related to data communication by a bus module 110 (e.g., time multiplexing, or arbitration, of audio data with non-multimedia data based on a quality of service (QoS) and/or priority of the data) as described herein.

The SoC 100 may further include a controller module 112 including a universal serial bus (USB) controller and one or more memory controllers (e.g., a dynamic random access memory (DRAM) memory controller). The SoC 100 may also include an input/output module 114 for communicating with resources external to the SoC, such as a clock and a voltage regulator, each of which may be shared by two or more of the internal SoC components.

The processors 102, 104, 106, 108 may be interconnected to the controller module 112, the memory module 116, the input/output module 114, system components and resources module 118, and other system components via a bus module 110, which may include an array of reconfigurable logic gates and/or implement a bus architecture (e.g., CoreConnect, AMBA, etc.). The bus module 110 may include any number of interconnecting buses and bridges depending on the specific application of the various processors 102, 104, 106, 108, and overall design constraints. The bus module 110 may communicate between the various modules and circuit components utilizing advanced interconnects, such as high performance networks-on-chip (NoCs). One or more of the NoCs may be implemented as an asynchronous NoC or a synchronous NoC. At least one processor of the processing system 120 is responsible for managing the bus module 110.

The bus module 110 may include or provide a bus controller 122 configured to grant SoC 100 components (e.g., processors, peripherals, modules, subsystems, etc.) exclusive control of the bus (e.g., to communicate data) for a set duration, number of operations, number of bytes, etc. In one aspect, the bus controller 122 may enable modules and circuit components connected to the bus module 110 to operate as a master component and initiate memory transactions. The bus controller 122 may also be configured implement an arbitration scheme to prevent multiple master components from attempting to drive the bus simultaneously.

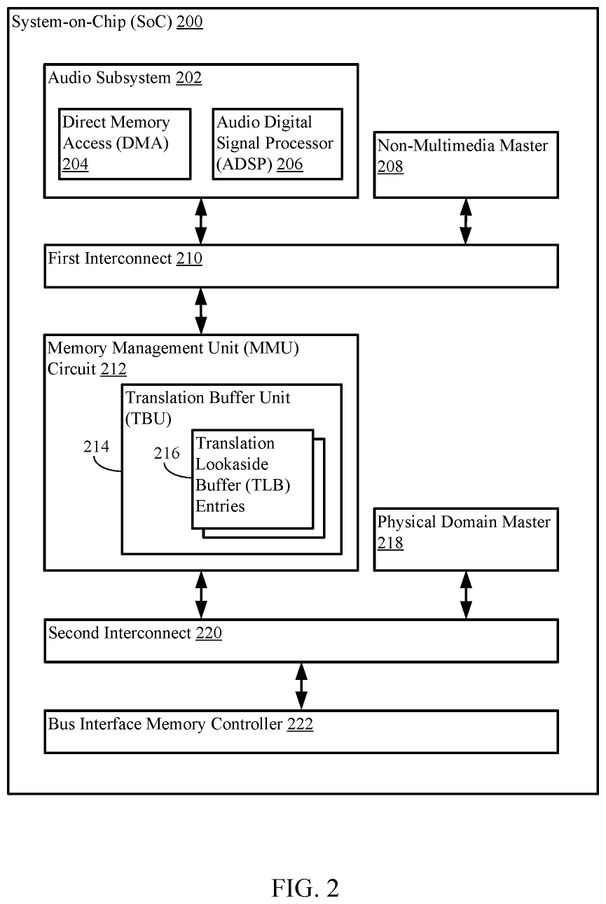

FIG. 2 is a block diagram conceptually illustrating an example hardware implementation of an SoC 200 having an audio subsystem 202, according to aspects of the present disclosure. The SoC 200 may include one or more modules and circuit components of the SoC 100 illustrated in FIG. 1. It should be noted that the SoC 200 described with respect to FIG. 2 is merely an example of a design principle for an SoC 200 containing an audio subsystem 202, and any specific number of elements (e.g., circuit components, interconnections, etc.) may be omitted for different implementations.

The SoC 200 may include a first interconnect 210 configured to provide data communication between an MMU 212 and both the audio subsystem 202 and one or more non-multimedia subsystems (represented generally by the non-multimedia master 208). The first interconnect 210 may include a NoC interconnect. In one example, the first interconnect 210 is an asynchronous NoC. The first interconnect 210 may enable a master/slave relationship between the audio subsystem 202, the non-multimedia master 208, and the MMU 212. For example, both the audio subsystem 202 and the non-multimedia master 208 may operate as master components, and the MMU 212 may operate as a slave component. Accordingly, the first interconnect 210 receives data from the audio subsystem 202 and the non-multimedia master 208, and then directs the received data to the MMU 212. The first interconnect 210 may direct data to the MMU 212 utilizing a single data path. The data path may be one of a 64-bit data path or a 128-bit data path.

The first interconnect 210 may implement an arbitration scheme configured to direct the received data to the MMU 212 based on a priority of the data. Generally, priority refers to the importance or time-sensitivity of the data. Thus, data having relatively higher importance and/or relatively greater time-sensitivity should be communicated to the MMU 212 before other data having relatively lesser importance and/or relatively lesser time-sensitivity. For example, data communicated by the audio subsystem 202 may have a greater priority than data communicated by the non-multimedia master 208. Accordingly, the first interconnect 210 may direct the received data to the MMU 212 utilizing a time-multiplexing arbitration scheme based on the priority of the data. For example, the first interconnect 210 may delay communicating data received from the non-multimedia master 208 to the MMU 212 until data received from the audio subsystem 202 is first communicated.

In one example, the first interconnect 210 may determine the priority of the received data based on a quality of service (QoS) requirement of the data. The QoS requirements associated with the received data may be determined by explicit indications in the data, or implicitly based on a source of the data. For example, the data received by the first interconnect 210 may include an explicit indication of a QoS requirement. Data having a relatively higher QoS requirement should be communicated prior to data having a relatively lower QoS requirement. In one configuration, the data received from the audio subsystem 202 includes an indication of a QoS requirement that is higher than a QoS requirement corresponding to data communicated by the non-multimedia master 208. Accordingly, the first interconnect 210 may delay communicating data received from the non-multimedia master 208 to the MMU 212 until data received from the audio subsystem 202 is first communicated.

Similarly, the first interconnect 210 may determine the priority of the received data implicitly. For example, priority may be based on a QoS requirement corresponding to a source from which the first interconnect 210 received the data. For example, the first interconnect 210 may be configured to assign a relatively higher QoS to data received from the audio subsystem than a QoS that corresponds to data received from the non-multimedia master 208.

The audio subsystem 202 includes a DMA 204 and an ADSP 206 configured to enable capture and play-back of audio. The audio subsystem 202 may include one or more sound driver(s) and audio packer router(s), and may be configured to receive data from other services or modules for playback. The ADSP 206 and the DMA 204 are configured to transfer data to the MMU 212, and may be configured to act (in furtherance of at least some transfers) as masters to the first interconnect 210. One or more of the ADSP 206 or the DMA 204 may be configured to set a QoS requirement indication in the data communicated to the first interconnect 210. The non-multimedia master 208 may communicate information including data relating to one or more of a peripheral device, cryptography, debugging, and resource management.

The MMU 212 may be configured to perform memory management, including address translation, cache control, and data arbitration. In one embodiment, the MMU 212 may include a translation buffer unit (TBU) 214, or any other suitable cache memory device, for reducing latencies associated with accessing a memory location. For example, the TBU 214 may include a plurality of memory cache entries such as translation lookaside buffer (TLB) entries 216. The TBU 214 is shared by the audio subsystem 202 and the non-multimedia master 208. Accordingly, fewer hardware components are required for implementation of the SoC relative to a conventional SoC that requires a dedicated TBU for each master and subsystem. Further, in certain aspects, complexity of design and cost of manufacturing may be reduced based on the use of a TBU 214 shared by the audio subsystem 202 and the non-multimedia master 208.

The MMU 212 may direct data from both the audio subsystem 202 and the non-multimedia master 208 to the shared TBU 214 based on the priority of the data. In one embodiment, the shared TBU 214 is partitioned in order to separate memory resources allocated for audio subsystem 202 data and non-multimedia master 208 data. The TBU 214 may include 128-TLB entries that are partitioned such that a first 64-TLB entries are configured to receive data from the audio subsystem 202, and a second 64-TLB entries are configured to receive data from the non-multimedia master 208. In some embodiments, the TBU 214 may control the storage of data such that the first 64-TLB entries are inaccessible to data from the non-multimedia master 208, and the second 64-TLB entries are inaccessible to data from the audio subsystem 202. Though certain embodiments described herein relate to a TBU 214 having a specific number of TLB entries, it should be noted that the similar techniques may be applied to memory cache entries having different configurations.

Accordingly, a user's experience with audio functionality is improved based on the use of a QoS mechanism for prioritizing data received from the audio subsystem 202. For example, a stream of audio data can be passed to the MMU 212 without being delayed by data from the non-multimedia master 208.

The SoC 200 may include a second interconnect 220 configured to provide data communication between a bus interface memory controller (BIMC) 222 and both the MMU 212 and a physical domain master 218. The second interconnect 220 may include a NoC interconnect. In one example, the first interconnect 210 is a synchronous NoC. Similar to the non-multimedia master 208, the physical domain master 218 may be a source of non-multimedia data. For example, the physical domain master may provide data relating to system components and resources, such as voltage regulators, oscillators, phase-locked loops, peripheral bridges, data controllers, system controllers, access ports, timers, peripheral device data, cryptography data, debugging data, and other similar components used to support the processors and software clients running on the computing device.

The second interconnect 220 may enable a master/slave relationship between the MMU 212, the physical domain master 218, and the BIMC 222. For example, both the MMU 212 and the physical domain master 218 may operate as master components, while the BIMC 222 may operate as a slave component. Similar to the first interconnect 210, the second interconnect 220 may implement an arbitration scheme configured to prioritize communication of data from the audio subsystem 202 to the BIMC 222, over communication of data from the physical domain master 218.

Accordingly, a user's experience with audio functionality is improved based on the use of a QoS mechanism for prioritizing data received from the audio subsystem 202. For example, a stream of audio data can be passed to the BIMC 222 without being delayed by data from the either of the non-multimedia master 208 or the physical domain master 218.

FIG. 3 is a flow diagram illustrating an example method 300 of managing memory resources between an audio subsystem and one or more non-multimedia subsystems, according to some aspects of the disclosure. As described below, some or all illustrated features may be omitted in a particular implementation within the scope of the present disclosure, and some illustrated features may not be required for implementation of all embodiments. In some examples, the method 300 may be carried out by the SoC 100 illustrated in FIG. 1 or the SoC 200 illustrated in FIG. 2. In some examples, the method 300 may be carried out by any suitable apparatus or means for carrying out the functions or algorithm described below.

At block 302, an interconnect may receive audio data from a first master, where the first master includes an audio subsystem. In some embodiments, the audio subsystem includes one or more of an ADSP and a DMA configured to communicate audio data. At block 304, the interconnect may receive non-multimedia data from a second master, where the second master includes a non-multimedia subsystem. In some embodiments, the interconnect is configured to time-multiplex the audio data with the non-multimedia data based on a quality of service (QoS) requirement of the data or of the data source (e.g., the audio subsystem or the non-multimedia subsystem).

At block 306, the interconnect may communicate the audio data to a first partition of an MMU, where the first partition is configured to be accessible by the first master and not the second master. In some embodiments, the MMU is a slave to the first master and the second master. For example, the MMU may be a slave to the ADSP and the DMA of the audio subsystem. In some embodiments, the MMU includes a TBU having a plurality of TLB entries. The first partition includes a first set of the plurality of TLB entries. The first partition is reserved for the audio data.

At block 308, the interconnect may communicate the non-multimedia data to a second partition of the MMU, where the second partition is configured to be accessible by the second master and not the first master, and communication of the audio data by the interconnect is prioritized over communication of the non-multi-media data. The second partition includes a second set of the plurality of TLB entries in the MMU. The second partition is reserved for the non-multimedia data. In some embodiments, the plurality of TLB entries in the MMU consist of 128 TLB entries, and each of the first set and second set of the plurality of TLB entries consist of 64 TLB entries. The TLB entries of the first set may be distinct to the TLB entries of the second set.

In some embodiments, the first partition and the second partition of the MMU are accessible by the interconnect via a same path. For example, the path may be a 128-bit data path. In some embodiments, the non-multimedia data includes one or more of peripheral data, cryptographic data, debugging data, and resource management data.

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A system on a chip (SoC) comprising:
a first master comprising an audio subsystem;
a second master comprising a non-multimedia subsystem;
a memory management unit (MMU) having a first partition and a second partition, wherein the first partition is configured to be accessible by the first master and not the second master, and wherein the second partition is configured to be accessible by the second master and not the first master; and
an interconnect configured to provide communication between the first master, the second master, and the MMU, wherein the interconnect is further configured to:
receive audio data from the first master,
receive non-multimedia data from the second master,
communicate the audio data to the first partition of the MMU,
communicate the non-multimedia data to the second partition of the MMU, wherein communication of the audio data over the interconnect is prioritized over communication of the non-multimedia data.

2. The SoC of claim 1, wherein the interconnect is further configured to time-multiplex the audio data with the non-multimedia data based on a quality of service (QoS) requirement.

3. The SoC of claim 1, wherein the MMU is a slave to the first master and the second master.

4. The SoC of claim 1, wherein the MMU comprises a plurality of translation lookaside buffer (TLB) entries, and wherein a first set of the plurality of TLB entries corresponds to the first partition and a second set of the plurality of TLB entries corresponds to the second partition.

5. The SoC of claim 4, wherein the plurality of TLB entries consist of 128 TLB entries, and wherein each of the first set and second set of the plurality of TLB entries consist of 64 TLB entries.

6. The SoC of claim 1, wherein the first partition and the second partition of the MMU are accessible by the interconnect via a same path.

7. The SoC of claim 1, wherein the first partition is reserved for the audio data and the second partition is reserved for the non-multimedia data.

8. The SoC of claim 1, wherein the audio data includes audio data, and wherein the non-multimedia data includes one or more of peripheral data, cryptographic data, debugging data, and resource management data.

9. The SoC of claim 1, wherein the first master includes one or more of a digital signal processor (DSP) and a direct memory access (DMA) unit configured to communicate audio data.

10. A method of sharing a memory management unit (MMU) between an audio subsystem and a non-multimedia subsystem, the method comprising:
receiving, via an interconnect, audio data from a first master, the first master comprising the audio subsystem;
receiving, via the interconnect, non-multimedia data from a second master, the second master comprising the non-multimedia subsystem;
communicating, via the interconnect, the audio data to a first partition of the MMU, wherein the first partition is configured to be accessible by the first master and not the second master; and
communicating, via the interconnect, the non-multimedia data to a second partition of the MMU, wherein the second partition is configured to be accessible by the second master and not the first master, and wherein communication of the audio data over the interconnect is prioritized over communication of the non-multimedia data.

11. The method of claim 10, further comprising time-multiplexing, via the interconnect, the audio data with the non-multimedia data based on a quality of service (QoS) requirement.

12. The method of claim 10, wherein the MMU is a slave to the first master and the second master.

13. The method of claim 10, wherein the MMU comprises a plurality of translation lookaside buffer (TLB) entries, and wherein a first set of the plurality of TLB entries corresponds to the first partition and a second set of the plurality of TLB entries corresponds to the second partition.

14. The method of claim 13, wherein the plurality of TLB entries consist of 128 TLB entries, and wherein each of the first set and second set of the plurality of TLB entries consist of 64 TLB entries.

15. The method of claim 10, wherein the first partition and the second partition of the MMU are accessible by the interconnect via a same path.

16. The method of claim 10, wherein the first partition is reserved for the audio data and the second partition is reserved for the non-multimedia data.

17. The method of claim 10, wherein the audio data includes audio data, and wherein the non-multimedia data includes one or more of peripheral data, cryptographic data, debugging data, and resource management data.

18. The method of claim 10, wherein the first master includes one or more of a digital signal processor (DSP) and a direct memory access (DMA) unit configured to communicate audio data.

19. An apparatus, comprising:
a means for generating audio data;
a means for generating non-multimedia data;
a means for storing comprising a first partition and a second partition, wherein the first partition is configured to be accessible by the audio data and not the non-multimedia data, and wherein the second partition is configured to be accessible by the non-multimedia data and not the audio data; and
a means for communicating between the means for generating audio data, the means for generating non-multimedia data, and the means for storing, wherein the means for communicating is further configured to:
receive audio data from the means for generating audio data,
receive non-multimedia data from the means for generating non-multimedia data,
communicate the audio data to the first partition, and
communicate the non-multimedia data to the second partition, wherein communication of the audio data is prioritized over communication of the non-multimedia data.

20. The apparatus of claim 19, wherein the means for storing comprises a plurality of translation lookaside buffer (TLB) entries, and wherein a first set of the plurality of TLB entries corresponds to the first partition and a second set of the plurality of TLB entries corresponds to the second partition.
